(19) United States
(12) Patent Application Publication
(10) Pub. No.: US 2026/0070171 A1
(43) Pub. Date: Mar. 12, 2026

(54) WORKPIECE CARRIER FRAME AND WORKPIECE CARRIER FRAME SYSTEM

(71) Applicant: Zell Systemtechnik GmbH, Ehingen-Volkersheim (DE)

(72) Inventor: Ingo Zell, Ehingen (DE)

(73) Assignee: Zell Systemtechnik GmbH, Ehingen-Volkersheim (DE)

(21) Appl. No.: 19/395,827

(22) Filed: Nov. 20, 2025

Related U.S. Application Data
(63) Continuation of application No. PCT/EP2024/064078, filed on May 22, 2024.

(30) Foreign Application Priority Data
May 22, 2023 (DE) 10 2023 113 330.6

(51) Int. Cl. B23Q 1/03

(52) U.S. Cl. CPC B23Q 1/03

(57) ABSTRACT

Workpiece carrier frame, comprising a plurality of frame corner modules, each comprising a plurality of corner elements, and a module frame that encloses an interior of the workpiece carrier frame laterally. The frame corner modules are arranged in corner regions of the workpiece carrier frame and their corner elements are arranged stacked on top of one another and are detachably connected to one another, so that two adjacent corner elements from each plurality of corner elements are arranged on at least one of the upper side and the lower side of the module frame and the module frame extends between the two adjacent corner elements.

### FIELD

The present disclosure relates to a workpiece carrier frame and a workpiece carrier frame system, from the components of which such a workpiece carrier frame can be assembled.

### BACKGROUND

A workpiece carrier basket is used to provide and hold one or more workpieces so that the workpieces can be supplied to and processed at one or more manufacturing stations as part of their manufacturing process, and/or transported between the manufacturing stations, and/or stored between the manufacturing steps. In the manufacturing stations, manufacturing steps such as washing, mechanical processing, or thermal hardening can be carried out.

A conventional workpiece carrier basket includes a frame and a carrier base. Workpieces can be placed on the carrier base and transported with the workpiece carrier basket. Workpiece holders can be arranged on the carrier base, through which workpieces are held in a desired position and grouped.

Changes in the production process can lead to the entire workpiece carrier basket having to be replaced, which involves effort and costs.

DE 10 2022 104 192 A1 shows a modular workpiece carrier frame that forms the circumferential side edge of a modular workpiece carrier basket.

### SUMMARY

It is an object to provide an improved workpiece carrier basket. It is another object to provide a workpiece carrier frame system that offers increased flexibility in adapting to different production processes. It is another object to provide a workpiece carrier frame that enables adaptation to different frame heights and dimensions. It is an object to provide a workpiece carrier frame that allows convenient modification or replacement of individual frame components. It is an object to provide a workpiece carrier frame that facilitates cost-effective reuse of structural components. It is an object to provide a workpiece carrier frame with enhanced structural stability, particularly for use in tall or multi-level frame configurations. It is an object to provide a workpiece carrier frame that enables secure and precise positioning of workpiece carriers or carrier plates. It is an object to provide a workpiece carrier frame that allows simple and safe stacking of multiple frames. It is an object to provide a modular system of workpiece carrier frame components that supports the construction of various frame configurations from a common component set. Finally, it is an object to provide a workpiece carrier frame that contributes to material savings, manufacturing efficiency, and simplified logistics in industrial environments.

According to an aspect of the present disclosure there is provided a workpiece carrier frame and a workpiece carrier frame system.

The workpiece carrier frame comprises a plurality of frame corner modules, each comprising a plurality of corner elements, and a module frame that encloses an interior of the workpiece carrier frame laterally. The frame corner modules are arranged in corner regions of the workpiece carrier frame, and their corner elements are stacked on top of each other and detachably connected to each other, so that two adjacent corner elements from each plurality of corner elements are arranged on the top side and bottom side of the module frame, respectively, and the module frame extends between the two adjacent corner elements.

In such a workpiece carrier frame, a carrier base can be used to form a workpiece carrier basket. The modular workpiece carrier frame comprises a plurality of frame corner modules made of several corner elements and at least one module frame. The components of the modular workpiece carrier frame can be assembled in a variable manner, allowing different workpiece carrier frames to be formed by the corner elements and the module frame. When a carrier base is inserted, the same applies to workpiece carrier baskets with such a workpiece carrier frame.

The components of the workpiece carrier frame are detachably assembled, allowing the size of the workpiece carrier frame to be easily modified by replacing the module frame. The height of the workpiece carrier frame depends on the number of corner elements stacked on top of each other in the frame corner modules and can be increased or decreased by adding or removing corner elements. The size of the module frame defines the length and width of the workpiece carrier frame. A carrier base can be inserted into the workpiece carrier frame to form a workpiece carrier basket for holding workpieces. By replacing the carrier base, the workpiece carrier basket can be easily adapted to a changed manufacturing process.

The frame corner modules form the corner regions of the workpiece carrier frame and are connected by the module frame. The number of frame corner modules is at least three, ideally four. The frame corner modules extend transversely to the frame. The side regions between the corner regions are formed by the at least one module frame, which extends through the frame corner modules in the corner regions. The module frame has a polygonal shape, e.g. a rectangular shape, so that the workpiece carrier frame also has a rectangular shape with four corner regions. The module frame can have a closed frame shape and can be configured, for example, from a rectangularly bent metal rod, particularly as a steel rod, whose ends are welded. The rod can have a round or polygonal cross-section.

Each frame corner module comprises at least two corner elements. The corner elements of a frame corner module are arranged one above the other in the vertical direction, that is, perpendicular to the module frame. “Top” and “Bottom” as well as derived terms, e.g., “top side” and “bottom side,” are opposite relative location designations. In relation to a usage position of a workpiece carrier basket with a workpiece carrier frame, the vertical direction corresponds to the filling direction of the workpiece carrier basket upwards. A carrier base of the workpiece carrier basket is at the bottom. Consequently, in the usage position, the corner elements are arranged vertically on top of each other on a horizontal plane in which the module frame is arranged.

The corner elements are detachably connected to each other, allowing the frame height to be changed by removing or adding one or more corner elements. The detachable connection can be made, for example, by suitable connecting means, e.g. screw connecting means. When assembling the corner elements into the frame corner module, the module frame is placed between two of the corner elements and fixed in position by connecting the corner elements.

The assembly of the corner elements can be supported by stacking lugs and stacking recesses on the corner elements, which interlock with the stacked corner elements. Stacking lugs can be provided on the top sides of the corner elements and stacking recesses on their bottom side, or vice versa. For the upper and lower corner elements of the frame corner module, stacking lugs or stacking recesses are only required on the undersides or top sides, respectively. Stacking lugs are projections whose shape corresponds to that of the stacking recesses, so that they interlock in a form-fitting manner and thereby align the corner elements with each other.

In various embodiments, the upper of the two adjacent corner elements, between which the module frame extends, has a structured underside, and the lower of the two adjacent corner elements, between which the module frame extends, has a structured top side. The structured top side and the structured underside of adjacent corner elements hold the module frame. Structured top side and structured underside mean that they are designed so that in adjacent, stacked corner elements, the top side and underside lie on each other and hold the module frame in a recess of the top sides and/or underside. The structured top side and the structured underside surround the module frame laterally. The structured top side and the structured underside can surround the module frame in a form-fitting manner, at least in sections, or completely. A module frame with a round cross-section can, for example, be enclosed in a circular arc of 270 degrees or 360 degrees. In this way, the module frame is secured against lateral slipping between the two corner elements. The structured top side and the structured underside touch in the areas lying on each other.

In an alternative embodiment, only one of the adjacent corner elements with a top side or underside facing each other has a structured top side or a structured underside, which is configured to accommodate the entire cross-section of the module frame. The other corner element prevents the movement of the module frame in the stacking direction. The top side and the underside, which face each other, hold the module frame, which extends in the structure on the top side or underside.

The top side and underside are structured in such a way that they hold the module frame in the structure. The structure, which accommodates a region of the module frame, can be configured on both the top side and the underside. The cross-section of the module frame then engages in both adjacent corner modules. Alternatively, the configuration is only configured in one corner module, which fully accommodates the cross-section; the other corner module covers the structure. The configuration can be groove-shaped and can correspond with the cross-section of the module frame.

A structured top side and/or structured underside can have not only the corner elements in the frame corner module, between which the module frame extends, but also other corner elements in the stack, so that another module frame can be easily inserted by releasing the connection between the corner elements, inserting the additional module frame, and reconnecting the corner elements.

The workpiece carrier frame can have at least a first and a second module frame, which are arranged one above the other. This increases the stability of the workpiece carrier frame, which is particularly beneficial for taller workpiece carrier frames. The first module frame is arranged between two adjacent corner elements from each plurality of corner elements and extends between them. The second module frame is arranged between two further adjacent corner elements from each plurality of corner elements and extends between them. In such an embodiment, at least two corner elements are arranged between the first and second module frames in each frame corner module. Alternatively, only one corner element can be provided between the first and second module frames. In this case, the first and second module frames are arranged between three adjacent corner elements, so that the first module frame extends between the two lower corner elements of the three corner elements and the second module frame extends between the two upper corner elements.

In various embodiments, the lower corner elements of the frame corner modules are configured as base elements, which have an inwardly projecting support on which a carrier base (carrier plate or support floor) can be placed and attached, for example, by means of detachable connecting means. Only the lower corner elements of the frame corner modules can be configured so that the carrier base can be placed on them. In a rectangular workpiece carrier frame, supports are provided in the four corner regions, so that the carrier base rests at its corners in the workpiece carrier frame.

In various embodiments, corner elements that are mounted on the base elements have a region projecting onto the carrier base, so that corner regions of the carrier base are arranged between the base elements as lower corner elements and the corner elements mounted on the base elements. The base elements each have a top-side recess for the corner region. In this embodiment, the corner regions of the carrier base are held above and below by adjacent corner elements. The carrier base is placed and fixed between the corner elements during the assembly of the frame corner modules.

In various embodiments, the upper corner elements of the frame corner modules are designed as edge elements, so that they form a non-continuous upper edge. The upper edge forms a closure of the workpiece carrier frame. The edge elements can have a structured underside for holding the module frame, but no structured top side. The same applies to the base elements, which can have a structured top side for holding the module frame, but no structured underside.

In various embodiments, the workpiece carrier frame is stackable by configuring its upper edge as a first stacking edge and configuring the undersides of the base elements to form a second stacking edge. Both stacking edges are not continuous. In the stacked state, the second stacking edge engages with the first stacking edge of another workpiece carrier frame on which the workpiece carrier frame is stacked, preventing lateral slipping of the workpiece carrier frame.

The two corner elements, between which the module frame or one of the module frames extends, can be configured as a first intermediate element that has both a structured top side and a structured underside for holding the module frame. The first intermediate element can be arranged between two module frames. Additionally or alternatively, a second and a third intermediate element can be provided as corner elements, between which the module frame or one of the module frames extends. The second intermediate element has only a structured top side for holding the module frame, but no structured underside. The third intermediate element has only a structured underside for holding the module frame, but no structured top side. When using only second and third intermediate elements, both a second and a third intermediate element must then be arranged between two module frames. A combination of the first intermediate element with either the second or third intermediate element to hold a module frame is also possible. Additionally, spacer elements can be provided, which can be placed between the aforementioned corner elements. Spacer elements cannot hold a module frame but allow the height of the workpiece carrier frame to be changed. The intermediate elements can be arranged between the base element and edge element.

Since the structure includes a recess for the module frame, an intermediate element that has either a structured top side or a structured underside is more stable than the first intermediate element with both a structured top side and a structured underside. The second and third intermediate elements can be flatter than the first intermediate element.

To change the frame height, corner elements that are designed as spacer elements can be provided. They have neither a structured top side nor a structured underside for holding the module frame, but instead act as spacers.

In various embodiments, the structured top side has a first groove, and the structured underside has a second groove. The first and second grooves form a continuous recess through which the module frame or one of the module frames extends. This recess can at least partially enclose the module frame laterally. The first groove and the second groove can each have an angled course that corresponds to the shape of the corner region of the module frame. The angled course can be rounded.

According to another aspect, there is provided a workpiece carrier frame system comprising a plurality of corner elements as well as at least one module frame. The plurality of corner elements can include a plurality of edge elements, base elements, and intermediate elements. The components can be assembled into a first workpiece carrier frame, and they can be assembled into a second workpiece carrier frame. The number of corner elements is sufficient to either assemble only one of the two workpiece carrier frames and assemble the other only after disassembling the one workpiece carrier frame, or to assemble both workpiece carrier frames simultaneously. The workpiece carrier frames differ in terms of their height, which is due to a different number of corner elements in the frame corner modules. In a workpiece carrier frame system with different module frames, the frame size can also be changed.

### BRIEF DESCRIPTION OF THE DRAWINGS

Embodiments of the invention are shown in the drawings and are explained in more detail in the following description.

FIG. 1 shows an example of a modular workpiece carrier basket with a workpiece carrier frame in a three-dimensional representation.

FIG. 2 shows the modular workpiece carrier basket in a three-dimensional exploded view.

FIG. 3 shows a corner region of the workpiece carrier basket from the outside in a three-dimensional representation.

FIG. 4 shows the corner region of the workpiece carrier basket from above in a three-dimensional representation.

FIG. 5 shows the corner region of the workpiece carrier basket from below in a three-dimensional representation.

FIG. 6 shows another exemplary embodiment of a modular workpiece carrier basket with a workpiece carrier frame in a three-dimensional representation.

FIG. 7 shows the other modular workpiece carrier basket in a three-dimensional exploded view.

FIG. 8 shows a corner region of the additional workpiece carrier basket from the outside in a three-dimensional representation.

FIG. 9 shows the corner region of the other workpiece carrier basket from above in a three-dimensional representation.

FIG. 10 shows the corner region of the additional workpiece carrier basket from below in a three-dimensional representation.

FIG. 11 shows another exemplary embodiment of a modular workpiece carrier basket with a workpiece carrier frame in a three-dimensional representation.

FIG. 12 shows the modular workpiece carrier basket in a three-dimensional exploded view.

FIG. 13 shows the corner region of the workpiece carrier basket from above in a three-dimensional representation.

FIG. 14 shows the corner region of the workpiece carrier basket from below in a three-dimensional representation.

FIG. 15 shows another exemplary embodiment of a modular workpiece carrier basket with a workpiece carrier frame in a three-dimensional representation.

In the figures, identical or functionally equivalent components are provided with the same reference numerals.

### DETAILED DESCRIPTION

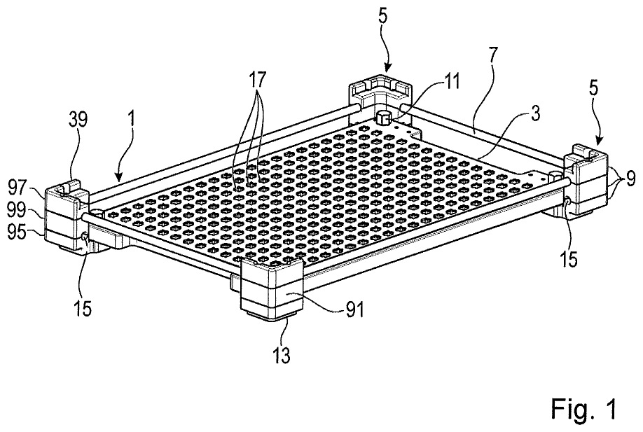

FIG. 1 shows an exemplary embodiment of a modular workpiece carrier basket with a workpiece carrier frame 1 and a carrier base 3 in a three-dimensional representation. Such a workpiece carrier frame 1 forms the surrounding lateral edge of the workpiece carrier basket. The carrier base 3 forms a support surface for workpieces and/or workpiece holders for accommodating workpieces.

The modular workpiece carrier frame comprises four frame corner modules 5 and a module frame 7. The workpiece carrier frame 1 is rectangular and has four corner regions. The frame corner modules 7 are arranged in the corner regions of the workpiece carrier frame 1 and extend transversely to the plane in which the module frame 7 extends. The module frame 7 extends through the frame corner modules 7.

Each of the frame corner modules 5 comprises three stacked corner elements 9, which are detachably connected to each other. The lower corner elements 9 of the frame corner modules 5 are configured as base elements 95, on which the carrier base 3 is placed and is fastened by detachable connecting means 11, namely screwable connecting means.

The upper corner elements 9 are configured as edge elements 97, so that they form a non-continuous upper edge of the workpiece carrier frame 1. The upper edge is configured as a first stacking edge, and undersides of the base elements 95 are configured as engaging portions 13 to a second stacking edge. The second stacking edge engages in the stacked state with the first stacking edge of another workpiece carrier frame 1, on which the workpiece carrier frame 1 is stacked, so that lateral slipping of the workpiece carrier frame 1 is prevented.

Between edge element 97 and base element 95, another corner element 9 is arranged as an intermediate element 99, through which edge element 97 and base element 95 are spaced apart. The module frame 7 extends between the edge elements 97 and the intermediate elements 99. The undersides of the edge elements 95 and the top sides of the intermediate elements 99 are structured in such a way that they form continuous recesses, in which the corner regions of the module frame 7 extend. The edge elements 97 and the intermediate elements 99 laterally surround the module frame 7 and hold it in its position.

The undersides of the intermediate elements 99 and the top sides of the base elements 95 are also structured so that they form continuous recesses 15. Although another module frame 7 could be inserted between the recesses 15, none is provided in this embodiment.

The carrier base 3 has a plurality of recesses 17, in which workpiece holders (not shown in FIG. 1) can be inserted in a variable arrangement. Due to its attachment by the detachable connecting means 11, the carrier base 3 can be replaced by an alternative carrier base, which is configured, for example, as a grid. Carrier bases 3 can be made of plastic or metal, for example.

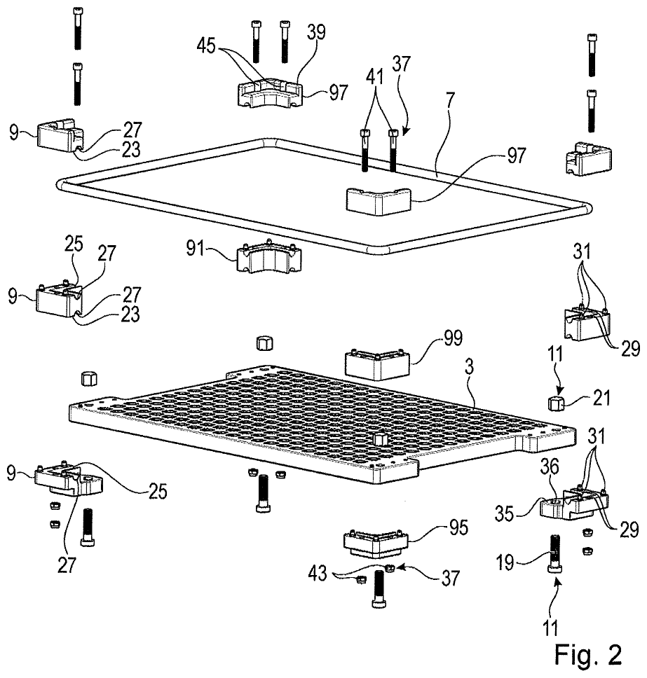

FIG. 2 shows the modular workpiece carrier basket from FIG. 1 in a three-dimensional exploded view. The workpiece carrier frame 1 includes the components shown except for the carrier base 3 and its connecting means 11, in this case screws 19 and cap nuts 21.

Each of the frame corner modules 5 comprises three stacked corner elements 9. The corner elements 9 are integrally formed and made, for example, of plastic. Such a corner element 9 can be easily manufactured as an injection-molded part.

The lower corner elements 9, designed as base elements 95, have an angular basic shape, the legs of which meet at right angles. Their structured top side 25 has a groove 27 running at right angles. The diameter and shape of the groove 27 correspond to a corner area of the module frame 7, so that its lower area can be inserted in the groove 27. In addition, three protruding pin-shaped stacking lugs 31 are provided on the top side 25, which are arranged in the corner and on the two legs. The base element 95 has two through-holes 29 for receiving connecting means 37. The holes 29 are arranged between the stacking lugs 31. Both the holes 29 and the stacking lugs 31 are arranged on the outside of the groove 27.

The base element 95 has an inwardly projecting support 35 in the lower region, on which the carrier plate 3 can be placed. The support 35 has a through-hole 36 for accommodating the connecting means 11, with which the carrier base 3 is detachably fastened to the base element 95.

The lower region of the base element 95 has an inwardly offset engaging portion 13, which forms a section of the second stacking edge. The upper region of the base module projects over the support 35 and thus forms a rectangular lateral stop to align the corner of the carrier base 3.

The upper corner elements 9, designed as edge elements 97, have an angular basic shape, with their legs meeting at a right angle. Their structured underside 23 features a groove 27 extending at a right angle, whose diameter and shape correspond with the corner region of the module frame 7, allowing its upper area to engage with the groove 27. Additionally, three blind hole-shaped stacking recesses are provided on the underside, arranged in the corner and the two legs. The edge element 97 also has two through-holes 29 for accommodating connecting means 37. Both the holes 29 and the stacking recesses are arranged outside the groove 27.

The stacking recesses and stacking lugs 31 of two corner elements 9 correspond in terms of shape and position. When corner elements 9 are stacked on top of each other, the stacking lugs 31 engage in the stacking recesses, so that the top side and underside of the corner elements 9 facing each other lie on top of each other, the holes 29 and grooves 27 are aligned on top of each other, and the grooves 27 form a continuous recess 15 for the module frame 7, which encloses it on the sides in a form-fitting manner.

The top side of the edge element 97 has an outwardly projecting region 39, which forms a section of the first stacking edge. The top side of the edge element 97 and the underside of the base element 95 are shaped so that the engaging portion 13 engages next to the projecting area 39 and the underside is secured against outward movement.

The corner elements 9, configured as intermediate elements 99, are arranged between the edge elements 97 and the base elements 95. They have an angular basic shape, whose legs meet at a right angle. They have structured top sides 25 and structured undersides 23 for holding the module frame 7 with grooves 27, holes 29, and stacking lugs 31 or stacking recesses, as previously described for the other corner elements 9. Such an intermediate element 99 with a structured top side 25 and structured undersides 23, into which the module frame 7 can engage, is a first intermediate element 91.

The frame corner modules 3 can each comprise one or more intermediate elements 99, which are stacked between edge element 97 and base element 95 and are connected with detachable connecting means 37. To connect the corner elements 9 of a frame corner module 5, two screw-screw nut connections are provided, the screws 41 of which engage through all corner elements 9 and are secured with screw nuts 43 on the underside of the base elements 95. Lowered portions 45 for the screw nuts 43 or the screw heads of the screws 41 are provided both in the base elements 95 and in the edge elements 97, so that the connecting means 37 are recessed and do not protrude.

In adjacent connected corner elements 9, the structured top side 25 and the structured underside 23 form the recess 15, in which a module frame 7 can be arranged. In this embodiment, such recesses 15 are configured both between edge element 97 and first intermediate element 91, as well as between base element 95 and first intermediate element 91. This allows two module frames 7 to be held on top of each other by the frame corner modules 5.

However, in this exemplary embodiment, only one module frame 7 is provided between the edge elements 97 and the first intermediate elements 91, which has been placed between them when assembling the edge elements 97 and the first intermediate elements 91.

The module frame 7 is configured as a rectangular closed metal frame with a round cross-section. Its ends can be connected, for example, by a welded joint. Alternatively, a gap can be provided between the ends.

In the workpiece carrier frame 1, assembled from the frame corner modules 5 and the module frame 7, the carrier base 3 is inserted. The carrier base 3 rests on the supports 35 of the base elements 95 and is fastened by connecting means 11. The size of the carrier base 3 corresponds to the frame size in such a way that it can be inserted into the frame and still rests on the supports 35. Connecting means 11 are screw-cap nut connections, with the cap nuts 21 arranged inside the workpiece carrier basket.

The described components allow the construction of various workpiece carrier baskets by assembling the components in different ways. A workpiece carrier basket, in particular its workpiece carrier frame 1, can be easily modified by simply exchanging, removing, or adding some of the components.

The height of the workpiece carrier basket depends on the number of corner elements 9, particularly the number of intermediate elements 99. In the simplest case, none is provided, and the edge elements 97 are arranged directly on the base elements 95. With an increasing number of intermediate elements 99, the height of the workpiece carrier basket increases. The provision of additional module frames 7 is optional, but it increases stability, especially with increasing frame height. Depending on the number of intermediate elements 99 used, the length of the screws 41 is chosen so that they do not protrude.

The carrier base 3 can be easily replaced by another carrier base 3.

The length and width of the workpiece carrier frame 1 are defined by the module frame 7. By replacing it, the length and width of the workpiece carrier frame 1 can be easily changed, which entails replacing the carrier base 3 with a carrier base 3 of the appropriate size.

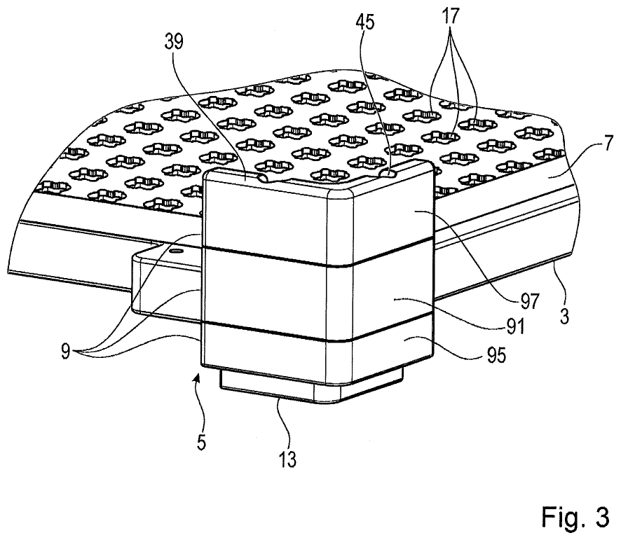

FIG. 3 shows in a three-dimensional detailed view the corner region of the workpiece carrier basket from the outside.

Edge element 97, first intermediate element 91, and base element 95 are arranged on top of each other and connected to each other. They form the frame corner module 5, where the module frame 7 extends between edge element 97 and first intermediate element 91. The top view contours of the corner elements 9 have the same shape, so that stacked corner elements 9 form frame corner modules 5 with straight side walls.

The top side of the edge element 97 and the underside of the base element 95 form sections of the first and second stacking edge, which interlock when workpiece carrier frames 1 or workpiece carrier baskets are stacked on top of each other.

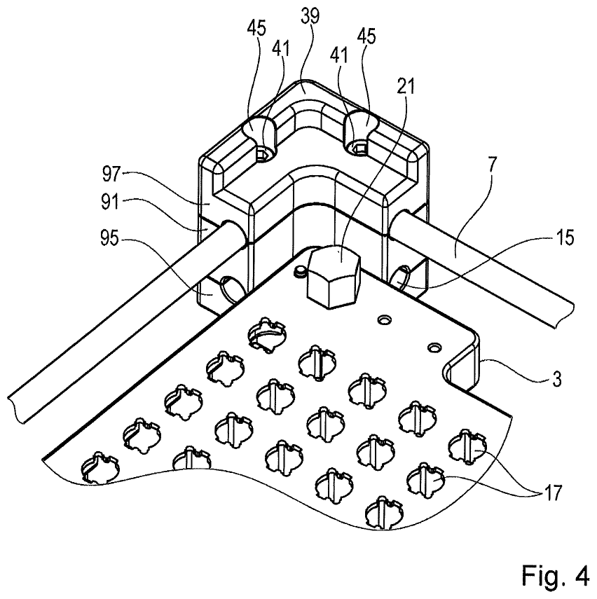

FIG. 4 shows a three-dimensional detailed view of the corner region of the workpiece carrier basket from above.

The inner side walls of the frame corner module 5 form a lateral stop to position the carrier base corner on the support 35 of the base element 95. The connection is made by a screw-cap nut connection, with the cap nut 21 arranged inside the workpiece carrier basket. The cap nut 21 with its round head prevents injuries.

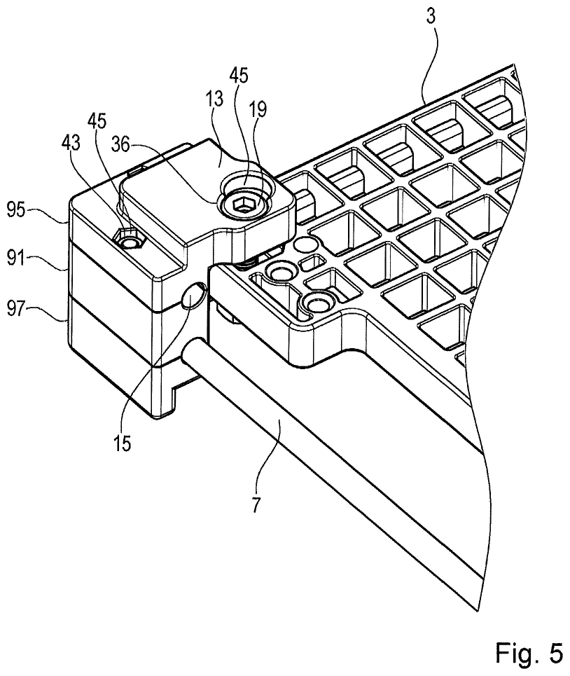

FIG. 5 shows in a three-dimensional detailed view the corner region of the workpiece carrier basket from below.

The corner elements 9 are connected by a screw 41, which runs through all the corner elements 9, and a screw nut 43 that secures the screw 41. The screw-screw nut connection is recessed. Corresponding lowered portions 45 are in edge element 97 and base element 95.

The carrier base 3 is attached to the support 35 by the screw 19 of the screw-cap nut connection passing through the holes in the support 35 and the carrier base 3. The hole 36 in the support 35 has a lowered portion 45 for the screw head. The hole 36 is configured as a double hole, allowing the screw 19 to occupy one of two positions, which provides degrees of freedom in the design of the carrier base 3.

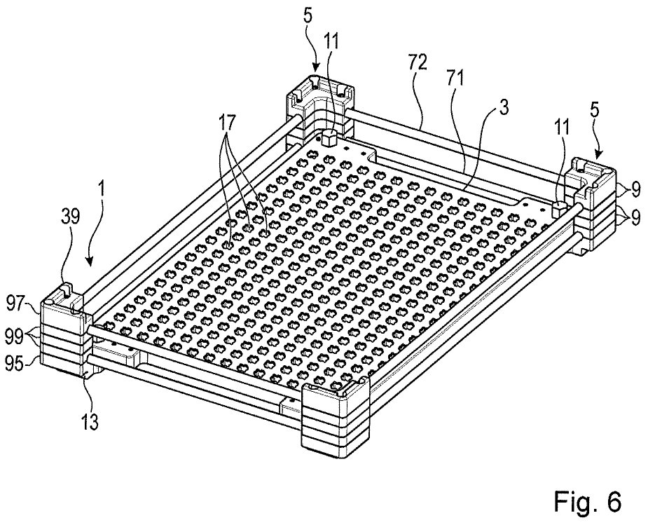

FIG. 6 shows another exemplary embodiment of a modular workpiece carrier basket with a workpiece carrier frame 1 and a carrier base 3 in a three-dimensional representation. The description for the following figures focuses on the differences with respect to the previous embodiment.

The modular workpiece carrier frame 1 comprises four frame corner modules 5 as well as a first module frame 71 and a second module frame 72, which are arranged one above the other and extend through the frame corner modules 5. The workpiece carrier frame 1 is rectangular and has four corner regions. The frame corner modules 5 are arranged in the corner regions of the workpiece carrier frame 1 and extend transversely to the module frames 71, 72.

Each of the frame corner modules 5 comprises five stacked corner elements 9, which are detachably connected to each other. The lower corner elements 9 of the frame corner modules 5 are configured as base elements 95, on which the carrier base 3 is mounted and fastened by screws 19 and cap nuts 21 as detachable connecting means 11.

The upper corner elements 9 are designed as edge elements 97, so that they form a non-continuous upper edge of the workpiece carrier frame 1. The upper edge is designed as a first stacking edge and the undersides of the base elements 95 form a second stacking edge, which interlock when two workpiece carrier frames 1 are stacked on top of each other.

Between edge element 97 and base element 95, three additional corner elements 9 are arranged as intermediate elements 99, so that edge element 97 and base element 95 are spaced apart. Edge elements 97, base elements 95, and two of the intermediate elements 99 are positioned directly above or below the module frames 71, 72. The intermediate elements 99 include second intermediate elements 92 or third intermediate elements 93. The first module frame 71 extends between the base elements 95 and the second intermediate elements 92. The second module frame 72 extends between the edge elements 97 and the third intermediate elements 93. Intermediate elements 99 as spacer elements 98 are arranged between the second and third intermediate elements 92, 93.

The base elements 95 have structured top sides 25 and the second intermediate elements 92 have structured undersides 23. The structured top sides 25 and undersides 23 form continuous recesses 15, between which the corner regions of the first module frame 71 extend. The corner elements 9 with mutually facing structured top side 25 and structured underside 23 surround the module frame 71 laterally and hold it in position. In the same way, the second module frame 72 is held, as the edge elements 95 have structured undersides 23, and the third intermediate elements 93 have structured top sides 25. The top sides of the second intermediate elements 92 and the undersides of the third intermediate elements 93 are not suitable for holding a module frame 71, 72. Between them, a spacer element 98 is arranged in each frame corner module 5. In the spacer element 98, neither the top side nor the underside is suitable for holding a module frame 71, 72. A module frame 71, 72 can only be positioned between two adjacent corner elements 9, one of which has a structured top side 25 and the other a structured underside 23, which is facing the structured top side 25.

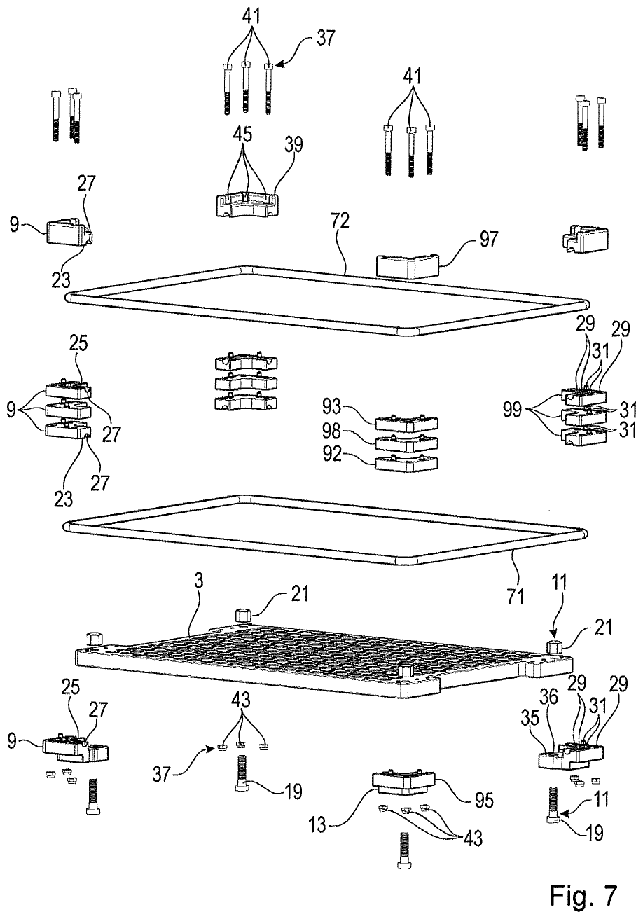

FIG. 7 shows the modular workpiece carrier basket from FIG. 6 in a three-dimensional exploded view. The workpiece carrier frame 1 includes the components shown except for the carrier base 3 and the screws 19 and cap nuts 21 for fastening the carrier base 3.

Each of the frame corner modules 5 comprises five stacked corner elements 9.

The lower corner elements 9, configured as base elements 95, have a right-angled basic shape. Their structured top side 25 features a groove 27 extending at a right angle, whose diameter and shape correspond with a corner region of the module frame 7, so that its lower region can be positioned in the groove 27. Two stacking lugs 31 are provided on the top side, arranged on the two legs. The base element 95 has three through-holes 29 for accommodating connecting means 37, which are arranged in the corners and the legs. Both the holes 29 and the stacking lugs 31 are arranged outside the groove 27.

The base element 95 has an inwardly projecting support 35 in the lower region, on which a carrier base 3 can be placed. In the support 35, there is a through-hole 36 for receiving connecting means 11, with which the carrier base 3 can be detachably fastened to the base element 95. The inner wall of the base element 95 above the support 35 forms a lateral stop for aligning the carrier base 3. The lower region of the base element 95 is configured as a section of a second stacking edge.

The upper corner elements 9, designed as edge elements 97, have a rectangular basic shape. Their structured underside 23 features a groove 27 extending at a right angle, whose diameter and shape correspond with the corner region of the module frame 7, allowing its upper region to engage in the groove 27. Additionally, two stacking recesses are provided on the underside. The edge element 97 has three through-holes 29 for accommodating connecting means 37.

The stacking recesses and stacking lugs 31 of two corner elements 9 correspond in terms of shape and position, so that when corner elements 9 are stacked on top of each other, the corner elements 9 lie on top of each other, the holes 29 are aligned with each other, the grooves 27 are aligned with each other, and the grooves 27 form a continuous recess 15 for the module frames 71, 72, so that the module frames 71, 72 are enclosed on the sides.

The top side of the edge element 97 has an outwardly projecting region 39, which forms a section of the first stacking edge. The stacking edges of two stacked workpiece carrier frames 1 engage in such a way that the upper workpiece carrier frame 1 is secured against outward movement and lateral slipping.

The corner elements designed as intermediate elements 99 are arranged between the edge elements 97 and the base elements 95. They have an angular basic shape. The second intermediate elements 92 have structured top sides 25 without grooves 27, but with holes 29 and stacking lugs 31 and undersides with stacking recesses and grooves 27. The third intermediate elements 93 have structured undersides 23 without grooves 27, but with holes 29 and stacking recesses and top sides with grooves 27 and stacking lugs 31. The spacer elements 98 have stacking lugs 31 and stacking recesses but no grooves 27. They are not suitable for holding the module frames 71, 72.

To connect the corner elements 9 of a frame corner module 5, two screw-nut connections are provided, with screws 41 passing through all corner elements 9 and secured with nuts 43 on the underside of the base elements 95. Both in the base elements 95 and in the edge elements 97, lowered portions 45 are provided for the nuts 43 or screw heads, so that the connecting means 37 do not protrude.

The described components allow the construction of various workpiece carrier baskets. The height of the workpiece carrier basket depends on the number of intermediate elements 99. Although not shown, it is of course also possible to combine a first intermediate element 91 with a second and/or a third intermediate element 92, 93 for holding a module frame 71, 72.

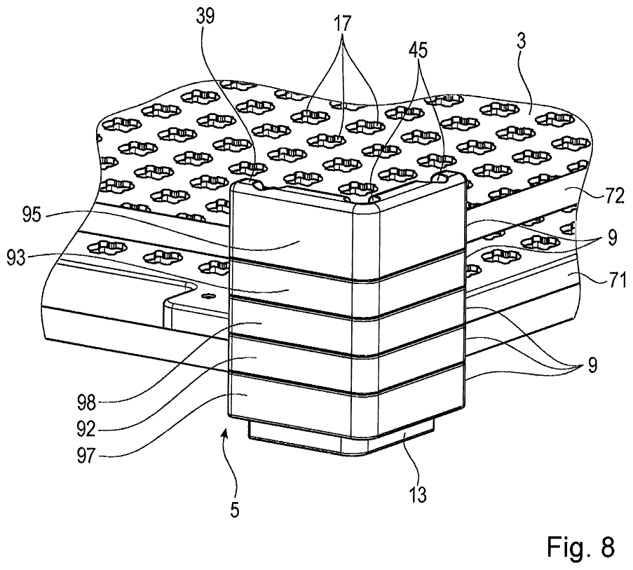

FIG. 8 shows a three-dimensional detailed view of the corner region of the workpiece carrier basket from the outside.

Edge elements 93, intermediate elements 99, and base elements 95 are arranged on top of each other and connected to each other. They form the frame corner module 5, through which the first and second module frames 71, 72 extend. The top side of the edge element 97 and the underside of the base element 95 form sections of the first and second stacking edges.

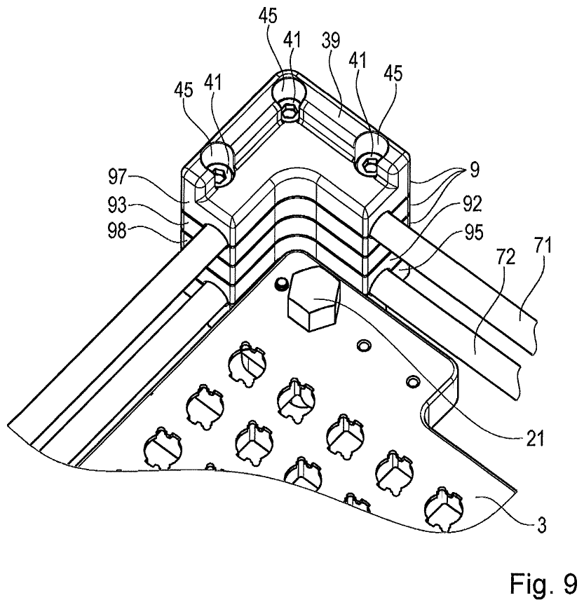

FIG. 9 shows in a three-dimensional detailed view the corner region of the workpiece carrier basket from above.

The inner side walls of the frame corner module 5 form a lateral stop for the carrier base 3. The carrier base 3 is attached to the base element 95 by a screw-cap nut connection, with the cap nuts 21 arranged inside the workpiece carrier basket.

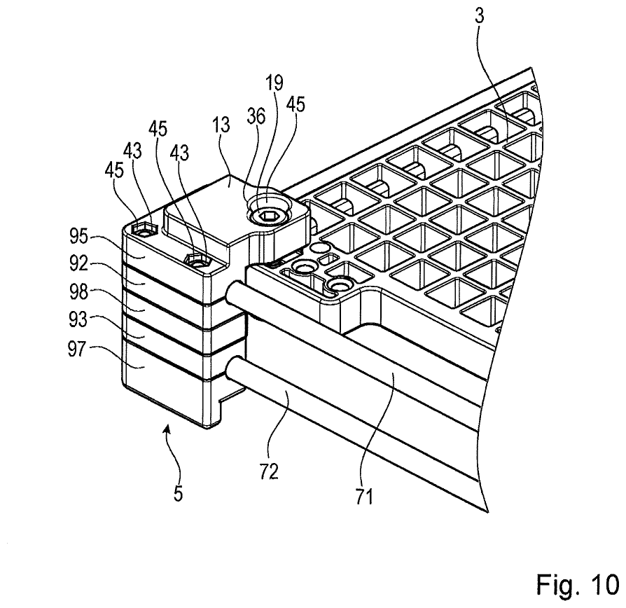

FIG. 10 shows in a three-dimensional detailed view the corner region of the workpiece carrier basket from below.

The corner elements 9 are connected by a screw 41, which runs through all the corner elements 9, and a screw nut 43 that secures the screw 41. The screw-screw nut connection is countersunk.

The carrier base 3 is secured on the support 35 by the screw 19 of the screw-cap nut connection passing through the holes in the support 35 and the carrier base 3. The hole 36 in the support 35 has a lowered portion 45 for the screw head. The hole 36 is configured as a double hole.

An exemplary embodiment of a workpiece carrier frame system includes a plurality of corner elements 9 as well as several module frames 7, 71, 72 of the same size and additional module frames 7, 71, 72 of different sizes. The plurality of corner elements 9 can include a plurality of edge elements 97, base elements 95, and intermediate elements 99. Furthermore, carrier bases 3 are included. In addition, fastening means 11, 37 for carrier bases and the connection of different numbers of corner elements 9 are provided. Such components are shown in the exploded views in FIG. 2 and FIG. 7.

The components can be assembled into various workpiece carrier frames 1, as described in connection with FIGS. 1 to 10, for example. The workpiece carrier frames 1 differ in terms of their height, which is due to a different number of corner elements 9. In a workpiece carrier frame system with different module frames 7, 71, 72, the frame size can also be changed. The carrier bases 3 are interchangeable.

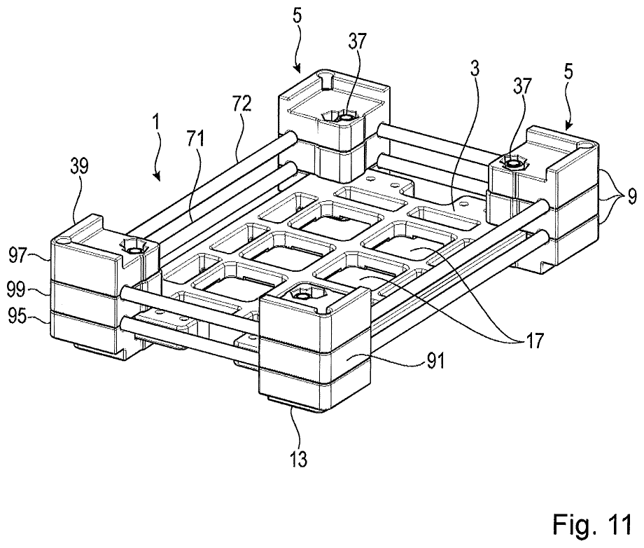

FIG. 11 shows another exemplary embodiment of a modular workpiece carrier basket with a workpiece carrier frame 1 and a carrier base 3 in a three-dimensional representation. The description for the following figures focuses on the differences with respect to the previous embodiments.

The modular workpiece carrier frame 1 comprises four frame corner modules 5 as well as a first module frame 71 and a second module frame 72, which are arranged one above the other and extend through the frame corner modules 5. The workpiece carrier frame 1 is rectangular and has four corner regions. The frame corner modules 5 are arranged in the corner regions of the workpiece carrier frame 1 and extend transversely to the module frames 71, 72.

Each of the frame corner modules 5 comprises three stacked corner elements 9, which are detachably connected to each other by screws 41 and screw nuts 43 as connecting means 37. The lower corner elements 9 of the frame corner modules 5 are designed as base elements 95. Intermediate elements 99 are placed on the base elements 95. The first module frame 71 extends between the base elements 95 and the intermediate elements 99. The second module frame 72 extends between the edge elements 97 as upper corner elements 9 and the intermediate elements 99.

The upper corner elements 9, which are placed on the intermediate elements 99, are configured as edge elements 97, so that they form a non-continuous upper edge of the workpiece carrier frame 1. The upper edge is configured as a first stacking edge, and undersides of the base elements 95 form a second stacking edge, which interlock when two workpiece carrier frames 1 are stacked on top of each other.

The base elements 95 in this exemplary embodiment have structured top sides 25, and the intermediate elements 99, which are configured as first intermediate elements 91, have structured undersides 23. The structured top sides 25 and undersides 23 form continuous recesses 15, between which the corner regions of the first module frame 71 extend. The corner elements 9 with their facing structured top side 25 and structured underside 23 surround the first module frame 71 laterally and hold it in position. In the same way, the second module frame 72 is held, as the edge elements 97 have structured undersides 23, and the first intermediate elements 91 also have structured top sides 25. A module frame 71, 72 can only be positioned between two adjacent corner elements 9, one of which has a structured top side 25 and the other a structured underside 23, which is facing the structured top side 25. In one exemplary embodiment, the intermediate element 91 has a greater height, so the workpiece carrier frame is also higher. The height can, for example, be oriented to customer specifications.

In this exemplary embodiment, the frame corner modules 5 have a square contour in the top view. The base elements 95 have a recess 94 on their top side for corner regions of a carrier base 3. The intermediate elements 99, which are mounted on the base elements 95 and adjacent to them, extend over the corner regions of the carrier base 3, so that the corner regions of the carrier base 3 are placed between adjacent base elements 95 and intermediate elements 99. An edge element 97 mounted on a base element 95 could also hold the corner region of the carrier base 3 in this way.

The connecting means 37 protruding through the stacked corner elements 9 of the frame corner modules 5 also engage through the corner regions of the carrier base 3 and form a solid connection of the components. Even without the connecting means 37 engaging through the carrier base 3, the carrier base 3 would still be held in a form-fitting manner.

The carrier base 3 is configured from plastic and has square recesses 17, into which workpiece holder modules (not shown in FIG. 11) can be inserted.

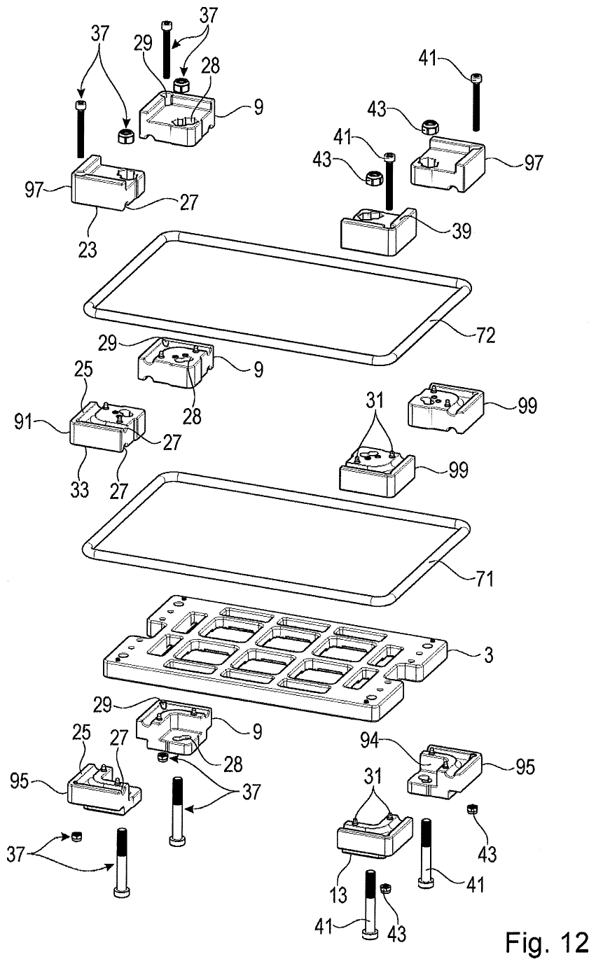

FIG. 12 shows the modular workpiece carrier basket from FIG. 11 in a three-dimensional exploded view.

Each of the frame corner modules 5 comprises three stacked corner elements 9. The lower corner elements 9, which are configured as base elements 95, have a square contour in the top view. Their structured top side 25 has a groove 27 extending at a right angle, whose diameter and shape correspond with a corner region of the module frame 71, so that its lower region can be positioned in the groove 27. Two stacking lugs 31 are provided on the top side. The base element 95 has two through-holes 28, 29 on both sides of the groove 27 in the inner and outer corner regions for accommodating connecting means 37.

The base elements 95 have a rectangular recess 94 on their top side, the underside of which forms the support for a corner region of the carrier base 3, which is positioned in the recess 94. The recess 94 is shaped so that its height corresponds to the height of the carrier base 3. The corner regions of the carrier base 3 can thus be placed flush on the top side and edge side in the recesses 94, so that the base elements 95 form an underside and edge-side stop for the carrier base 3. The lower region of the base element 95 is configured as a section of a second stacking edge.

The upper corner elements 9, designed as edge elements 97, have a square contour in the top view. Their structured underside 23 features a groove 27 extending at a right angle, whose diameter and shape correspond with the corner region of the module frame 7, allowing its upper area to engage in the groove 27. Additionally, two stacking recesses are provided on the underside, into which the stacking lugs 31 of an adjacent corner element 9 can engage. The edge element 97 has two through-holes 29, 28 for accommodating connecting means 37.

The stacking recesses and stacking lugs 31 of two corner elements 9 correspond in terms of shape and position, so that when corner elements 9 are stacked on top of each other, the corner elements 9 lie on top of each other, the holes 28, 29 are aligned with each other, the grooves 27 are aligned with each other, and the grooves 27 form a through-hole recess 15 for the module frames 71, 72, so that the cross-sections of the module frames 71, 72 are enclosed laterally in the corner regions.

The top side of the edge element 97 has an outwardly projecting region 39, which forms a section of the first stacking edge. The stacking edges of two stacked workpiece carrier frames 1 engage in such a way that the upper workpiece carrier frame 1 is secured against outward movement and lateral slipping.

The corner elements 9, designed as intermediate elements 99, are arranged between the edge elements 97 and the base elements 95. They have a cuboid basic shape with a square base side. The first intermediate elements 91 have through-holes 28, 29 and structured top sides 25 and structured undersides 23 with grooves 27 and stacking lugs 31 or stacking recesses.

Although in this exemplary embodiment only first intermediate elements 91 are shown, in alternative embodiments, second intermediate elements 92 with grooves 27 only on the underside 23, third intermediate elements 93 with grooves only on the top side 25, or spacer elements 98 without grooves 27 can also be provided. The described components allow the construction of various workpiece carrier baskets. The height of the workpiece carrier basket essentially depends on the number of intermediate elements 99. More or fewer than two module frames 71, 72 can be provided.

To connect the corner elements 9 of a frame corner module 5, two screw-nut connections are provided. The screws 41 pass through the holes 28, 29 and are held with hexagonal nuts 43. Both the screw heads and the nuts 43 are countersunk. The screws 41 in the inner holes 28 extend in the opposite direction to those in the outer holes 29.

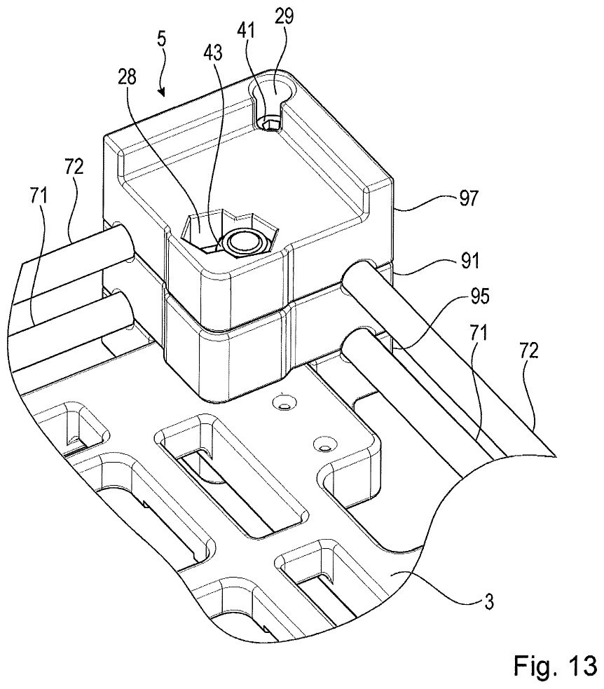

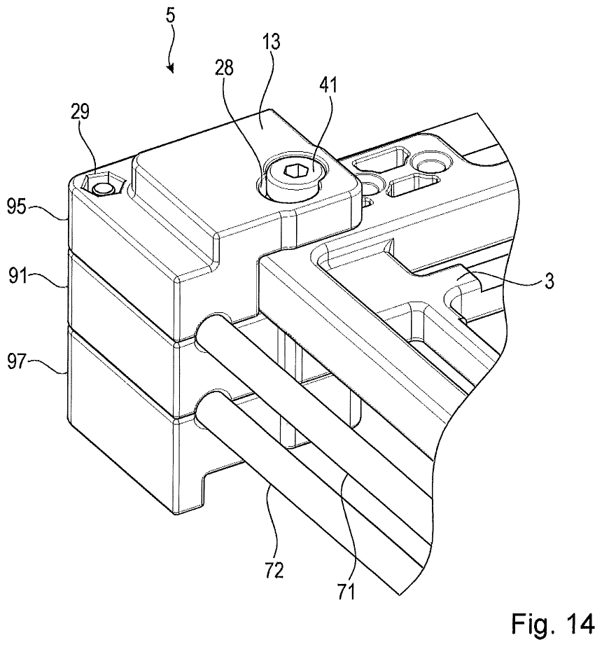

FIG. 13 shows a three-dimensional detailed view of the corner region of the workpiece carrier basket from above. FIG. 14 shows a three-dimensional detailed view of the corner region of the workpiece carrier basket from below. FIGS. 13 and 14 are described together below.

The corner region of the carrier base 3 is positioned between the base element 95 and the first intermediate element 91. Connecting means 37 engage through an outer corner region of the frame corner module 5 and through an inner corner region of the frame corner module 5. The screw 41 positioned in the outer corner region engages only through the stacked corner elements 9. The screw 37 positioned in the inner corner region engages both through the stacked corner elements 9 and through the carrier base 3.

The holes 28 in the inner corner region are shaped as double holes so that the screws 37 and screw nuts 43 can be placed in one of two positions. The position adjacent to the short side is preferred. The double hole has an upper-side lowered portion with a polygonal contour to prevent the rotation of the screw nut 43. However, the corresponding holes in the corner regions of the carrier base 3 are not double holes but are shaped so that the position of the screws 41 is specified adjacent to the short side of the workpiece carrier frame 1.

Screws 41 in the outer corners pass through all corner elements 9 and are secured with screw nuts 43 on the underside of the base elements 95. Both in the base elements 95 and in the edge elements 97, lowered portions 45 are provided for the screw nuts 43 or screw heads, so that the connecting means 37 do not protrude. The lowered portions for the screw nuts 43 have a hexagonal contour to hold the screw nut 43 in place. Screws 41 in the inner corners pass through all corner elements 9 and the carrier base 3 and are secured with screw nuts 43 on the top side of the edge elements 97.

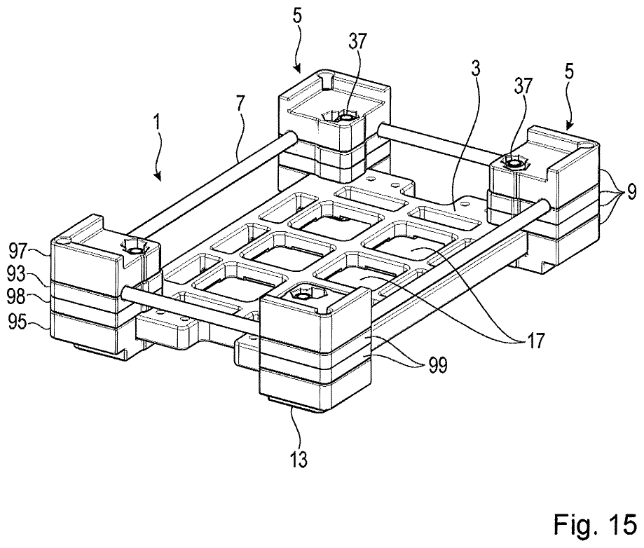

FIG. 15 shows another embodiment of a modular workpiece carrier basket with a workpiece carrier frame 1 and a carrier arch 3 in a three-dimensional representation. The description for this figure focuses on the differences from the previous embodiment.

In this exemplary embodiment, only one module frame 7 is provided. The base element 95 does not have an upper groove for a module frame. Two flat intermediate elements 99 are arranged between the edge elements 97 and the base elements 95. The upper intermediate element 99 is configured as a third intermediate element 93, which has only an upper groove 27, but no lower groove. The lower intermediate element 99 is configured as a spacer element 98 without grooves 27.

The embodiments illustrated in the figures exemplify the degrees of freedom that the various corner modules 9, in particular differently designed intermediate elements 99, offer when assembling a workpiece carrier frame 1.

The features mentioned above and those specified in the claims, as well as those discernible from the figures, can be advantageously implemented both individually and in various combinations. The invention is not limited to the described embodiments but can be modified in many ways within the scope of professional expertise.

The phrase at least one of A, B, and C should be construed to mean a logical (A OR B OR C), using a non-exclusive logical OR, and should not be construed to mean “at least one of A, at least one of B, and at least one of C.”

Reference sign

| | |
|---|---|
| 1 | Workpiece carrier frame |
| 3 | Carrier base (Support floor) |
| 5 | Frame corner module |
| 7 | Module frame |
| 9 | Corner element |
| 11 | Connecting means |
| 13 | Engaging portion |
| 15 | Recess |
| 17 | Recess |
| 19 | Screw |
| 21 | Cap nut |
| 23 | Structured underside |
| 25 | Structured top side |
| 27 | Groove |
| 29 | Hole |
| 31 | Stacking lug |
| 35 | Support |
| 36 | Hole |
| 37 | Connecting means |
| 39 | Protruding region |
| 41 | Screw |
| 43 | Screw nut |
| 45 | Lowered portion |
| 71 | First module frame |
| 72 | Second module frame |
| 91 | First intermediate element |
| 92 | Second intermediate element |
| 93 | Third intermediate element |
| 94 | Recess |
| 95 | Base element |
| 97 | Edge element |
| 98 | Spacer element |
| 99 | Intermediate element |

1-19. (canceled)

20. A workpiece carrier frame, comprising:
a plurality of frame corner modules, each comprising a plurality of corner elements; and
a module frame that encloses an interior of said workpiece carrier frame laterally, wherein the frame corner modules are arranged in corner regions of said workpiece carrier frame and their corner elements are arranged stacked on top of one another and are detachably connected to one another so that two adjacent corner elements from each of the plurality of corner elements are arranged on at least one of an upper side and a lower side of the module frame and the module frame extends between the two adjacent corner elements.

21. The workpiece carrier frame of claim 20, wherein at least one of (i) the upper of the two adjacent corner elements, between which the module frame extends, have a structured underside, and (ii) the lower of the two adjacent corner elements, between which the module frame extends, have a structured top side, and wherein the structured top side and the structured underside are designed to lie on each other and hold the module frame arranged between them.

22. The workpiece carrier frame of claim 21, wherein the frame corner modules include further corner elements comprising at least one of a structured top side and a structured underside.

23. The workpiece carrier frame of claim 20, wherein the module frame is a first module frame and said workpiece carrier frame comprises a second module frame which is arranged above the first module frame, and wherein two adjacent corner elements from each plurality of corner elements are arranged on at least one of a top side and a bottom side of the second module frame and the second module frame extends between the two adjacent corner elements, and wherein one or more corner elements are arranged between the first and the second module frame in each frame corner module.

24. The workpiece carrier frame of claim 20, wherein the corner elements have stacking lugs and stacking recesses that interlock with the stacked corner elements.

25. The workpiece carrier frame of claim 20, wherein the lower corner elements of the frame corner modules are configured as base elements, the base elements having an inwardly projecting support on which a carrier base can be placed.

26. The workpiece carrier frame of claim 25, wherein the base elements have a structured top side.

27. The workpiece carrier frame of claim 25, wherein the corner elements, which are mounted on the base elements, have a region projecting onto the carrier base so that corner regions of the carrier baser are arranged between the base elements and the corner elements positioned on the base elements.

28. The workpiece carrier frame of claim 20, wherein the upper corner elements of the frame corner modules are configured as edge elements, the edge element forming a non-continuous upper edge.

29. The workpiece carrier frame of claim 28, wherein the edge elements have a structured underside.

30. The workpiece carrier frame of claim 28, wherein the upper edge is configured as a first stacking edge and undersides of base elements form a second stacking edge, which in the stacked state engages into the first stacking edge of another workpiece carrier frame on which said workpiece carrier frame is stacked.

31. The workpiece carrier frame of claim 21, wherein one of the two corner elements, between which the module frame extends, is configured as a first intermediate element that has both a structured top side and a structured underside.

32. The workpiece carrier frame of claim 31, wherein the lower of the two corner elements, between which the module frame extends, is configured as a second intermediate element that has a structured top side, and the upper of the two corner elements, between which the module frame extends, is configured as a third intermediate element that has a structured underside.

33. The workpiece carrier frame of claim 21, wherein the structured top side has a first groove and the structured underside has a second groove, and wherein the first and second grooves form a continuous recess through which the module frame extends.

34. The workpiece carrier frame of claim 33, wherein the first and second grooves form a continuous angled recess.

35. The workpiece carrier frame of claim 20, further comprising:
four corner regions, wherein the module frame is rectangular.

36. The workpiece carrier frame of claim 20, further comprising:
connecting features that connect the corner elements of the frame corner modules.

37. The workpiece carrier frame of claim 36, wherein the connecting features are screws.

38. The workpiece carrier frame system of claim 20, wherein
the module frame can be assembled into a first workpiece carrier frame with a first height and a second workpiece carrier frame with a second height, and wherein the first height is different than that of the second height.
